(19) United States
(12) Patent Application Publication
(10) Pub. No.: US 2006/0137255 A1
(43) Pub. Date: Jun. 29, 2006

(54) Weather strip for vehicle

(75) Inventor: Masahiro Nozaki, Nishikasugai-gun (JP)

Correspondence Address: POSZ LAW GROUP, PLC, 12040 SOUTH LAKES DRIVE, SUITE 101, RESTON, VA, 20191, US

(73) Assignee: TOYODA GOSEI Co., Ltd., Aichi-ken (JP)

(21) Appl. No.: 11/312,832

(22) Filed: Dec. 21, 2005

(30) Foreign Application Priority Data
Dec. 28, 2004 (JP) 2004-379527

(51) Int. Cl. E06B 7/16

(52) U.S. Cl. 49/498.1; 49/489.1

(57) ABSTRACT

A weather strip includes a fixing base fixed to a periphery of a door that closes an opening in a vehicle body. A seal portion of the weather strip is unitarily formed with the fixing base, and the seal portion includes a hollow seal portion that seals between the door and a rim of the opening. A seal bridge of the weather strip is formed in the hollow seal portion and unitarily extends from the fixing base to an inside wall of the hollow seal portion where the opening rim contacts the hollow seal portion. The seal bridge of the weather strip is formed in a curved shape and divides the hollow seal portion into a plural space. The seal bridge reduces noise without significantly increasing the door closing force.

### CROSS REFERENCE TO RELATED APPLICATION

This application is based on and incorporates by reference Japanese Patent Application No. 2004-379527, which was filed on Dec. 28, 2004.

### BACKGROUND OF THE INVENTION

1. Field of the Invention

The present invention generally relates to weather strips, and specifically to a weather strip that seals between the body of a vehicle and a closing member for an opening in the body. The weather strip may be fixed at a door of the vehicle or a trunk lid of the vehicle.

2. Related Art

As shown in FIG. 6 and 7, a door weather strip 110, which is generally fixed at a periphery of a door frame 2 of a door 1, and an opening weather strip 130, which is fixed at a flange 6a, seal between the door 1 and a rim 6 of an opening in the vehicle body. A glass run 120, which is fixed at a channel 3 inside of the door frame 2, seals between a door glass 5 and the door 1.

The glass run 120 is fixed at the channel 3. The glass run 120 includes an outer side wall 121, a bottom wall 122 and an inner side wall 123, and forms a U-shape that encloses the edge of the door glass 5. An outer seal lip 124, which extends from the outer side wall 121, and an inner seal lip 125, which extends from the inner side wall 123, contact and seal both sides of the door glass 5. The opening weather strip 130 is fixed by a U-shape trim portion 131 at the flange 6a. A hollow seal portion 132 of the opening weather strip 130 contacts an inside surface of the door frame 2 to form a seal.

The door weather strip 110, which is fixed at the periphery of the door frame 2, includes a fixing base 111. A hollow seal portion 114 and a seal lip 116 are unitarily formed with the fixing base 111. The fixing base 111 is fixed on a retainer 4 that is formed on the door frame 2. When the door 1 is closed, the seal lip 116 contacts an outer edge of the opening rim 6 of the vehicle body and seals between an outer periphery of the door frame 2 and the opening rim 6 of the vehicle body. Then, the hollow seal portion 114 contacts an inside surface of the opening rim 6 and seals between the door 1 and the opening rim 6.

The seal portion, such as the hollow seal portion 114 or the seal lip 116, of the weather strip 110 is formed by sponge material that is flexible for sealing with the opening rim 6 of the vehicle body. The seal portion also inhibits noise from entering the passenger compartment. The seal portion 114, 116 is insufficient by itself to reduce noise in the passenger compartment. Therefore, as shown in FIG. 8, a seal bridge 115 is formed in the hollow seal portion 114 of the opening weather strip, and the seal bridge 115 performs as a sound insulating wall.

As shown in FIG. 9, the seal bridge 115 is also formed and bent in the hollow seal portion 114, and the seal bridge 115 extends from the fixing base 111 to an edge of the hollow seal portion 114. When the door 1 is closed, the hollow seal portion 114 is pressed and deformed by the opening rim 6. The seal bridge 115 is also deformed and performs as a sound insulating wall inside of the hollow seal portion 114.

In these cases, the seal bridge 115 is deformed in accordance with the deformation of the hollow seal portion 114, but the deformation of the seal bridge 115 is not consistent. The seal bridge 115 occasionally contacts an inside wall of the hollow seal portion 114 or is folded in the hollow seal portion 114. In this case, the level of sound insulation is decreased, and the force required to close the door 1 is increased.

In other prior art, a plurality of sound insulating projections is formed in an alternating fashion from the hollow seal portion and the fixing base 111. In this case, however, the form of the hollow seal portion 114 and the fixing base 111 becomes complicated. Therefore, it is difficult to manufacture the seal portion 114 with the sound insulating projections, and the door closing force is increased because the sound insulating projections interfere with each other in the hollow seal portion 114 when the door 1 is closed. Also, the sound insulating performance is decreased because there is a clearance between these projections.

### SUMMARY OF THE INVENTION

An object of the invention is to overcome the above-mentioned limitations. A weather strip of the present invention insulates noises without increasing a closing force of the weather strip.

Basically, a weather strip of the invention includes a fixing base fixed at a periphery of a door that closes an opening in a vehicle body. A seal portion of the weather strip is unitarily formed with the fixing base, and the seal portion includes a hollow seal portion that seals between the door and a rim of the opening. A seal bridge of the weather strip is formed in the hollow seal portion and unitarily extends from the fixing base to an inside wall of the hollow seal portion where the opening rim contacts the hollow seal portion. The seal bridge of the weather strip is formed in a curved shape and divides the hollow seal portion into a plurality of spaces.

### BRIEF DESCRIPTION OF THE DRAWINGS

The accompanying figures, in which like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 is a cross sectional view of a door weather strip fixed on an upper portion of a door frame at line A-A in FIG. 6;

FIG. 2 is a cross sectional view of the door weather strip being pressed by an opening rim of a vehicle body;

FIG. 3 is a cross sectional view of the door weather strip fixed on a lower portion of the door frame;

FIG. 4 is a cross sectional view of a molded part of the weather strip;

FIG. 5 is an enlarged view of part A in FIG. 2;

FIG. 6 is a side view the vehicle;

FIG. 7 is a cross sectional view of a prior art door sealing structure at line A-A in FIG. 6;

FIG. 8 is a cross sectional view of a prior art opening trim weather strip; and

FIG. 9 is a cross sectional view of a prior art door weather strip.

### DETAILED DESCRIPTION OF THE PREFERRED EMBODIMENTS

A weather strip of the present invention seals between a body of a vehicle and a closing member that seals an opening in the vehicle body. Thus, the weather strip can be a door weather strip, an opening trim weather strip, or a trunk weather strip. Hereinafter, a door weather strip 10 will be described as a representative form of the weather strip.

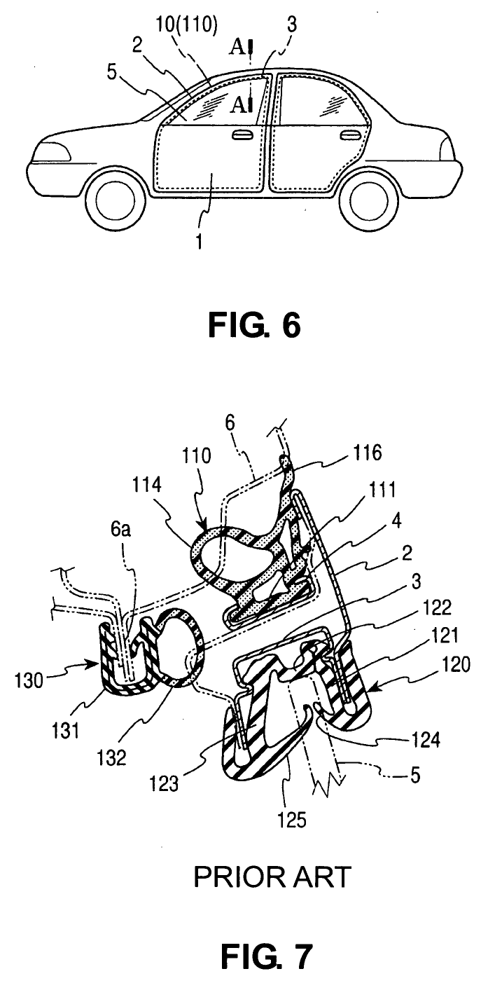

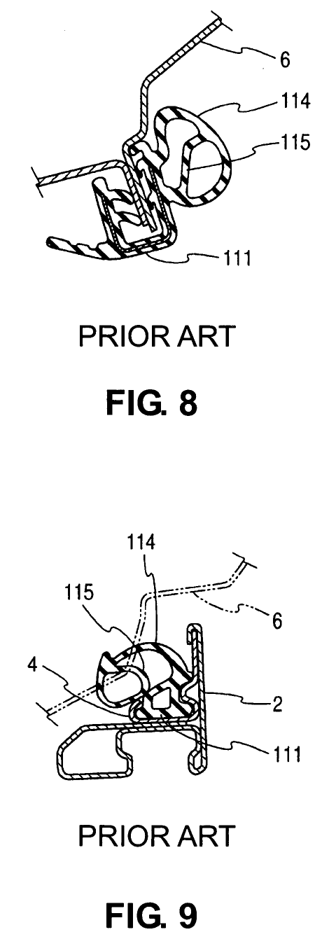

Referring to FIG. 6, a vehicle door 1 includes a door frame 2 and a door glass 5 that moves up and down. The door weather strip 10 is fixed around the door frame 2, and the door weather strip 10 seals between the door 1 and an opening rim 6 of the vehicle. Also, a channel 3 is formed on an inside part of the door frame 2. A glass run in the channel 3 guides the motion of the door glass 5 and seals between the door glass 5 and the door frame 2.

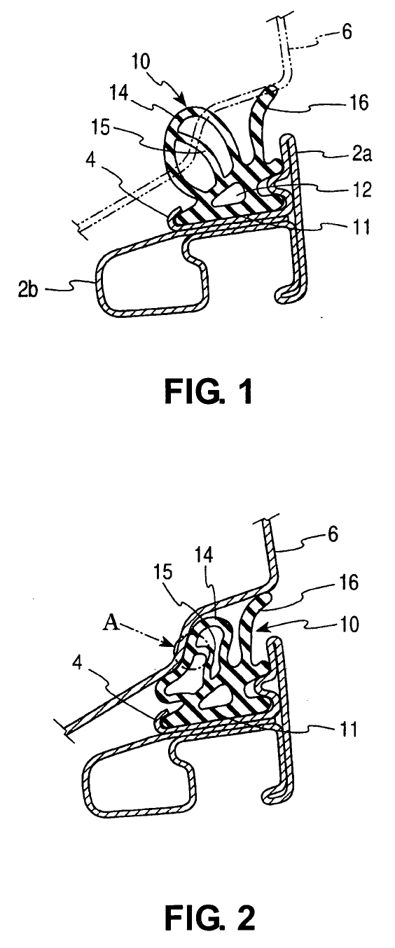

Referring to FIG. 1, the door weather strip 10 includes an extruded part and a molded part. The extruded part has an elongated straight body and is formed by an extruder, and the molded part is formed at a corner of the weather strip 10 and is formed by a mold apparatus. The corner of the weather strip 10 corresponds to a corner of the door frame 2. The molded parts of the weather strip 10 connect the extruded parts at each corner of the door frame 2. Thus, the weather strip 10 is formed in an annular shape and surrounds the door 1.

As shown in FIG. 1, a cross section of the weather strip 10 includes a fixing base 11, which is fixed to a top part of the door frame 2, and a seal portion, which is integrally and unitarily formed on the outer side of the fixing base 11. The seal portion includes a seal lip 16 and a hollow seal portion 14. The seal lip 16 seals between the periphery of the door frame 2 and an outer section of the opening rim 6. The hollow seal portion 14 contacts an inner section of the opening rim 6. The seal portion can be composed of the hollow seal portion 14 without the seal lip 16.

In cross section, the fixing base 11 generally has the shape of a letter A that is resting on its side. The fixing base 11 includes a hollow portion 12, thus the weight of the door weather strip 10 is reduced.

As described later, the fixing base 11 shown in FIG. 1 is fixed to a retainer 4 that is fixed on an outer surface of the door frame 2. The retainer 4 is unitarily formed by an outer panel 2a of the door frame 2. The retainer 4 can also be formed as a separate part that is fixed on the upper surface of the outer panel 2a. Because of the hollow portion 12 of the fixing base 11, the fixing base 11 is flexible. Therefore, it is easy to fit the fixing base 11 in the retainer 4. The fixing base 11 is preferably formed from solid rubber for secure retention by the retainer 4.

As shown in FIG. 1, the fixing base 11 is securely fixed to the retainer 4, but the fixing base 11 can also be fixed to the outer part of the door frame 2 by double sided adhesive tape, without the retainer 4. In this case, the weight of the door frame 2 is reduced because the retainer 4 is omitted, and the seal performance between the door frame 2 and the fixing base 11 is improved because the fixing base is adhered to the door frame 2 with the double sided adhesive tape.

Still referring to FIG. 1, the hollow seal portion 14 includes a circular or elliptical cross section and extends obliquely from the fixing base 11. As shown in FIG. 2, when the door is closed, an end of the hollow seal portion 14 is elastically deformed by a bulge in the opening rim 6. Thus, the hollow seal portion 14 seals between the door frame 2 and the opening rim 6.

The hollow seal portion 14 and the seal lip 16 form a double seal to exclude rainwater and dust between the door frame 2 and the opening rim 6. Although the fixing base 11 is preferably made of solid rubber, the hollow seal portion 14 is preferably formed from sponge rubber for ease of deformation for seal performance, and weight reduction.

A seal bridge 15 is formed inside of a hollow region of the hollow seal portion 14. The seal bridge is formed from the same material as the hollow seal portion 14. The seal bridge 15 unitarily extends from the fixing base 11 to an inside wall of a portion where the opening rim 6 contacts the hollow seal portion 14. The seal bridge 15 divides the hollow region of the hollow seal portion 14 into two spaces, thus the seal bridge 15 serves as a noise insulating wall. When the hollow seal portion 14 contacts the opening rim 6 and is deformed, the seal bridge 15 is deformed or bent in the hollow seal portion 14.

The seal bridge 15 is formed in curved shape in order to bend easily when the hollow seal portion 14 contacts the opening rim 6. In FIG. 2, the hollow seal portion 14 is deformed in an outward direction of the vehicle when the opening rim 6 contacts the hollow seal portion 14, and the seal bridge 15 is also deformed outwardly. The curved shape of the seal bridge 15 is formed in accordance with the deformation direction of the hollow seal portion 14. Thus, the hollow seal portion 14 located at the top part of the door frame 2 is deformed outwardly.

Because of the curved shape of the seal bridge 15, the hollow seal portion 14 and the seal bridge 15 are deformed in the same manner. Therefore, when the door is closed, the door closing force that is needed to close the door is limited even though the seal bridge 15 is formed in the hollow seal portion 14.

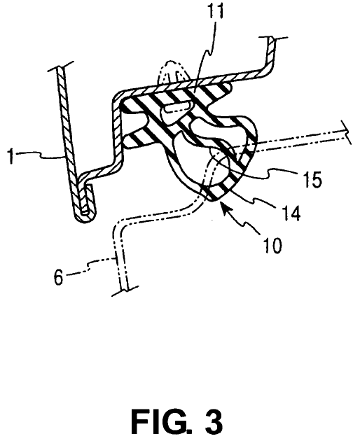

In FIG. 3, the fixing base 11 of the weather strip 10 is fixed on a bottom part of the door 1. An outer end of the hollow seal portion 14 of the weather strip 10 contacts a bulge of the opening rim 6, when the door 1 is closed. The hollow seal portion 14 is compressed in an inward direction of the vehicle by the bulge of the opening rim 6. The seal bridge 15 is deformed in the same manner as the hollow seal portion 14 because the seal bridge 15 is curved in accordance with the deformation direction of the hollow seal portion 14. Thus, the door closing force is limited. Therefore, the seal bridge 15 serves as a noise insulating wall without significantly increasing the door closing force.

As mentioned above, the hollow seal portion 14 located at the top part of the door frame 2 deforms outwardly, and the hollow seal portion 14 located at the bottom part of the door 1 deforms inwardly. The deformation directions of the seal portions between the top part and the bottom part of the weather strip 10 are opposed in order to adjust the door closing force and the seal performance.

As shown in FIG. 5, a recess 15b can be formed at or in close proximity to a junction where the hollow seal portion 14 meets the seal bridge 15. When the hollow seal portion 14 deforms and the seal bridge 15 bends, the recess 15b facilitates bending of the seal bridge 15 at the location of the recess 15b.

The thickness of the seal bridge 15 is constant in the longitudinal direction and in the lateral direction except where the recess 15b is located. Therefore, the seal bridge 15 flexes uniformly along its length when the door 1 is closed. Therefore, the seal bridge 15 does not cause a significant increase in the force required to close the door 1 regardless of the extent of the deformation.

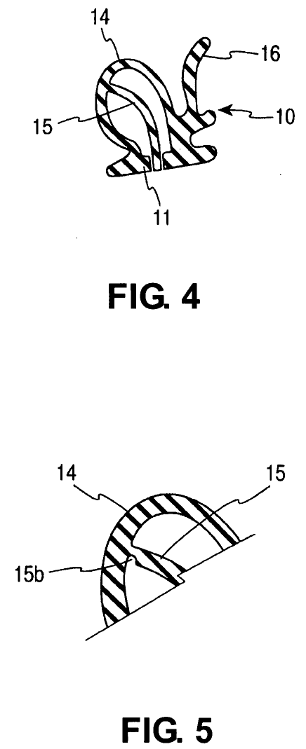

A corner part of the weather strip 10, which is formed by molding, corresponds to a corner part of the door frame 2. As shown in FIG. 4, the fixing base 11 of the corner part is divided into two parts. The hollow seal portion 14 includes hollow regions in order to improve its flexibility and noise insulating characteristics. A mold apparatus for molding the corner part includes two internal mold members for forming the hollow regions. The fixing base 11 is divided into two parts to permit removal of the internal mold members. The seal bridge 15 is molded between the internal mold members. Thus, one end of the seal bridge 15 is a free end between the fixing bases 11, and the other end of the seal bridge 15 connects with the hollow seal portion 14. When the weather strip 10 is fixed to the door 1, the end of the seal bridge 15 is held by the fixing bases 11. Then, the seal bridge 15 serves as a noise insulating wall. The seal bridge 15 of the molded part of the weather strip 10 is molded to be continuous with the seal bridge 15 of the extruded part of the weather strip 10.

The seal lip 16 extends from the fixing base 11, and is curved as shown. The seal lip 16 can be formed from solid rubber or sponge rubber. When the seal lip 16 is made of solid rubber, the surface of the seal lip 16 is flat and smooth, and the appearance of the seal lip 16 is improved. When the seal lip 16 is made of sponge rubber, the seal lip 16 has good noise insulating performance because sponge rubber is a good noise insulator.

Now a method of manufacturing the weather strip will be explained. The manufacturing method is substantially the same of weather strips used between various closing members and various openings. That is, the manufacturing method is substantially the same for the door weather strip 10, an opening weather strip, a trunk weather strip and a back door weather strip. Hereinafter, the method of manufacturing the door weather strip 10 will be explained as a representative of the weather strips.

A straight part (extruded part) of the door weather strip 10 can be formed from synthetic rubber, thermoplastic elastomer, or flexible synthetic resin. For example, the synthetic rubber can be EPDM rubber, the thermoplastic elastomer can be olefinic thermoplastic elastomer, and the flexible synthetic resin can be flexible PVC (polyvinyl chloride). For more flexibility, these materials are preferably formed with an effervescent agent as a sponge material.

When synthetic rubber is used, synthetic rubber is vulcanized and foamed by hot air and high-frequency heating in a vulcanizing device after extrusion. When thermoplastic elastomer or flexible synthetic resin is used, thermoplastic elastomer or flexible synthetic resin is heated on or after extrusion, and solidified by cooling. Then the extruded part is cut in a predetermined length. In this way, the straight portion is manufactured.

Now a method of manufacturing the molded part, which is a corner part of the weather strip 10, will be explained. An end of the extruded part is set in a mold apparatus for the molded part. Then, sponge material or solid material is injected into a cavity of the mold apparatus. The material for the molded part is preferably the same kind of material used for the extruded part. When synthetic rubber is used, the molded part is heated in the mold apparatus after injecting the material. Then the molded part is united with the extruded part by vulcanization because the material of the molded part is made from the same or the same kind of the material as the extruded part. When thermoplastic elastomer or flexible synthetic resin is used, the molded part is united with the extruded part by melting fusion because the injected material is melted and fused with the extruded part by heat and injection pressure.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A weather strip for sealing between an opening of a vehicle and a closing member, which closes the opening in the body, comprising:
a fixing base, which is fixed at a peripheral part of the closing member;
a seal portion unitarily formed with the fixing base, wherein the seal portion includes a hollow seal portion and seals between the peripheral part of the closing member and a rim of the opening;
a seal bridge formed in the hollow seal portion, wherein the seal bridge extends from the fixing base to an inside wall of the hollow seal portion where the rim contacts the hollow seal portion, and wherein the seal bridge is formed in a curved shape and divides the hollow seal portion into a plurality of spaces.

2. A weather strip according to claim 1, wherein the closing member is a door, and the fixing base is fixed at top part of the door, and the hollow seal portion and the seal bridge are deformed in an outward direction of the vehicle when the door is closed.

3. A weather strip according to claim 1, wherein the closing member is a door, and the fixing base is fixed at a bottom part of the door, and the seal portion and the seal bridge are compressed in an inward direction of the vehicle when the door is closed.

4. A weather strip according to claim 1, wherein the weather strip is a door weather strip, which is formed in an annular shape surrounding the door, and a part of the hollow seal portion that is located at a top part of the door is deformed in an outward direction of a vehicle, and the hollow seal portion that is located at a bottom part of the door is deformed in an inward direction of the vehicle.

5. A weather strip according to claim 1, wherein the thickness of the seal bridge is substantially constant.

6. A weather strip according to claim 1, wherein the seal bridge includes a recess formed in close proximity to a junction where the hollow seal portion meets the seal bridge.

7. A weather strip according to claim 1, wherein a corner part of the weather strip is a molded part, and a fixing base of the molded part is divided into two parts, one end of the seal bridge is a free end located between the two parts, and another end of the seal bridge connects with the hollow seal portion.

8. A weather strip according to claim 1, wherein the seal portion includes a seal lip that forms a seal between a peripheral edge of the closing member and an outer section of the opening rim.

9. A weather strip according to claim 1, wherein the fixing base is formed from a solid material, and the seal portion is formed from a sponge material.

10. A weather strip according to claim 1, wherein the seal portion is formed from sponge material of EPDM rubber or olefinic thermoplastic elastomer.

11. A weather strip according to claim 1, wherein the fixing base is formed from solid material of EPDM rubber or olefinic thermoplastic elastomer.

12. A weather strip for sealing an opening of a vehicle, comprising:
a plurality of extruded parts, wherein each extruded part includes a first fixing base fixed at an outer periphery of a door frame, and a first hollow seal portion, which seals between the door frame and a vehicle body, wherein the first hollow seal portion has a first seal bridge, which divides the first hollow seal portion into two hollow regions; and
a plurality of molded corner parts, wherein each molded corner part connects a pair of adjacent extruded parts such that the weather strip surrounds the door frame, wherein each molded corner part includes a second fixing base, which is fixed at the periphery of the door frame, and a second hollow seal portion, which seals between the door frame and the vehicle body, and wherein the second hollow seal portion has a second seal bridge that divides the second hollow seal portion into two hollow regions,
wherein the first seal bridge and the second seal bridge are continuous.

13. A weather strip according to claim 12, wherein a part of the first hollow seal portion that is located at an top part of the door frame is deformed in an outward direction of a vehicle, and the first hollow seal portion located at a bottom part of the door frame is deformed in an inward direction of the vehicle.

14. A weather strip according to claim 12, wherein each molded corner part is fixed to a corner of the door frame, and the second fixing base is divided into two parts, and one end of the second seal bridge is a free end located between the two parts, and the other end of the seal bridge connects with the hollow seal portion.

15. A weather strip, comprising:
a fixing base adapted to be fixed at a peripheral part of a closing member that closes an opening;
a hollow seal portion formed with the fixing base, wherein the hollow seal portion is adapted to seal between the peripheral part of the closing member and a rim of the opening;
a seal bridge formed in the hollow seal portion, wherein the seal bridge extends from the fixing base to an inside wall of the hollow seal portion where the rim is adapted to contact the hollow seal portion, and wherein the seal bridge is formed in a curved shape and divides the hollow seal portion into a plurality of spaces.

16. A weather strip according to claim 15, wherein the weather strip is formed in an annular shape, and the seal bridge is continuously formed along the annular shape.

17. A weather strip according to claim 16, wherein a corner part of the weather strip is a molded part, and a fixing base of the molded part is divided into two parts, and wherein one end of the seal bridge is a free end located between the two parts, and another end of the seal bridge connects with the hollow seal portion.
